(19) United States
(12) Patent Application Publication
(10) Pub. No.: US 2024/0428426 A1
(43) Pub. Date: Dec. 26, 2024

(54) INFORMATION PROCESSING DEVICE AND INFORMATION PROCESSING METHOD

(71) Applicant: Sharp NEC Display Solutions, Ltd., Tokyo (JP)

(72) Inventor: Isao TAKAHASHI, Tokyo (JP)

(21) Appl. No.: 18/826,976

(22) Filed: Sep. 6, 2024

Related U.S. Application Data
(63) Continuation of application No. PCT/JP2022/011004, filed on Mar. 11, 2022.

(51) Int. Cl. G06T 7/20; G06V 10/44; G06V 20/52; G06V 40/20

(52) U.S. Cl. CPC G06T 7/20; G06V 10/44; G06V 20/52; G06V 40/20

(57) ABSTRACT

A tracking unit is configured to track a person by detecting at least a subsequent position of the person in a range where content can be visually recognized during a period when the content is displayed on a display device. A behavior detection unit is configured to detect behavior of the person related to the content. A storage unit stores the behavior and visual recognition opportunity information, which is information corresponding to the presence of the person in the range during the period, in association with each other on the basis of a tracking result of the tracking unit without association with person identification information for identifying the person.

### TECHNICAL FIELD

The present invention relates to an information processing device and an information processing method.

### BACKGROUND ART

There is a system for measuring the advertising effect of a display such as digital signage by determining whether or not a person is viewing an advertisement displayed on the display and tracking the face of the person viewing the advertisement when the person is viewing the advertisement (see, for example, Patent Document 1).

Moreover, there is a shelf system for performing effective promotion in accordance with a customer's behavior on a product (for example, Patent Document 2). This system analyzes a video of a signage system or a camera attached to a signage display and displays advertisements matching the customer's needs, thereby encouraging the customer to purchase products.

However, these systems store and use personal information for identifying an individual. Therefore, from the viewpoint of protecting privacy information, it is preferable to take care so that a degree to which personal information of a person is used is not increased. On the other hand, it is difficult to ascertain what type of behavior (a product purchase, application, payment, or the like) a person viewing the advertisement has taken afterwards without identifying the individual.

### CITATION LIST

### Patent Document

[Patent Document 1]
Japanese Unexamined Patent Application, First Publication No. 2011-70629
[Patent Document 2]
Japanese Patent No. 6264380

### SUMMARY OF INVENTION

### Technical Problem

The present invention provides an information processing device and an information processing method for preventing a degree to which personal information of a person is used from increasing from the viewpoint of protecting privacy information and ascertaining the behavior of a person.

### Solution to Problem

In order to solve the above-described problems, according to an aspect of the present disclosure, there is provided an information processing device including: a tracking unit configured to track a person by detecting at least a subsequent position of the person in a range where content can be visually recognized during a period when the content is displayed on a display device; a behavior detection unit configured to detect behavior of the person related to the content; and a storage unit configured to store the behavior and visual recognition opportunity information, which is information corresponding to the presence of the person in the range during the period, in association with each other on the basis of a tracking result of the tracking unit without association with person identification information for identifying the person.

Moreover, according to an aspect of the present invention, there is provided an information processing method including: tracking a person by detecting at least a subsequent position of the person in a range where content can be visually recognized during a period when the content is displayed on a display device; detecting behavior of the person related to the content; and storing the behavior and visual recognition opportunity information, which is information corresponding to the presence of the person in the range during the period, in association with each other in a storage unit on the basis of a tracking result without association with person identification information for identifying the person.

### Advantageous Effects of Invention

It is possible to ascertain the behavior of a person while preventing a degree to which personal information of the person is used from increasing.

### BRIEF DESCRIPTION OF DRAWINGS

FIG. 1 is a schematic configuration diagram for describing a configuration of a content display system S.

FIG. 2 is a schematic block diagram for describing a function of an information processing device 30.

FIG. 3 is a diagram showing an example of measurement information stored in a storage unit 304.

FIG. 4 is a flowchart for describing an operation of the content display system S.

FIG. 5 is a conceptual diagram for describing a flow of a process of the content display system S.

FIG. 6 is a schematic configuration diagram showing a configuration of a content display system Sa according to another embodiment.

FIG. 7 is a schematic block diagram showing a configuration of an information processing device 30a according to the other embodiment.

FIG. 8 is an explanatory diagram showing an operation of a content display system S according to yet another embodiment.

FIG. 9 is a schematic block diagram for describing a function of an information processing device 30b according to yet another embodiment.

### DESCRIPTION OF EMBODIMENTS

Next, an aspect of the present invention will be described in detail with reference to the drawings.

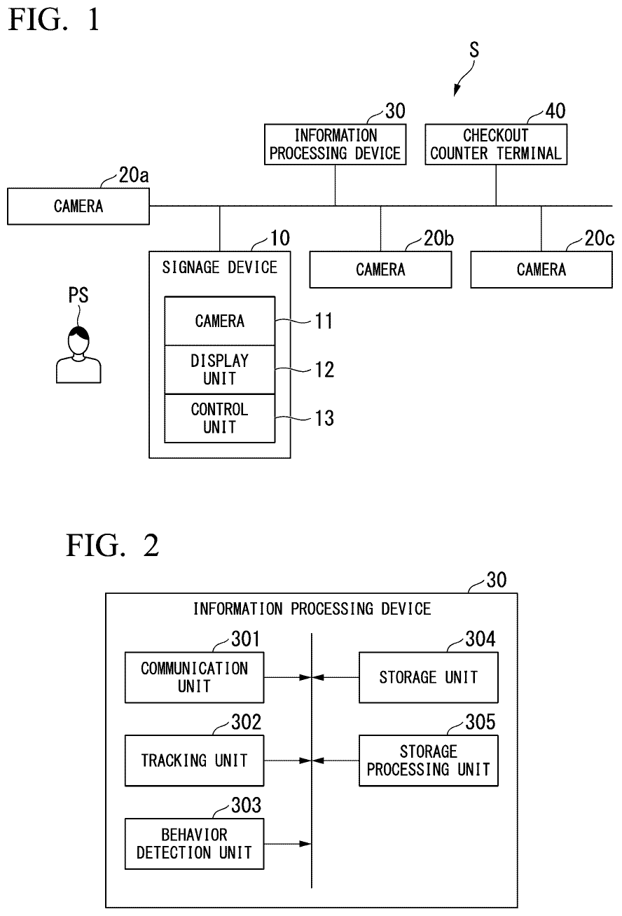

FIG. 1 is a schematic configuration diagram for describing a configuration of a content display system S in the present disclosure.

In the content display system S, a signage device 10, a plurality of cameras (a camera 20a, a camera 20b, and a camera 20c), an information processing device 30, and a checkout counter terminal 40 are electrically connected via a communication cable.

The signage device 10, the camera 20a, the camera 20b, and the camera 20c are provided in a target area for measuring the content viewing effect and, for example, are provided in any one of a shopping mall, a store, a public facility, and the like. In the present embodiment, the signage device 10 is provided in the vicinity of the entrance of the store (e.g., outside of the entrance) and at a position where the content displayed on the signage device 10 can be visually recognized outside of the store.

The signage device 10 includes a camera 11, a display unit 12, and a control unit 13. The signage device displays the content on the display unit 12. The content may be either a still image or a moving image. The content may be, for example, any one of advertisements, notices, guidance, news, and the like. Here, a case where the content is an advertisement related to a product of a store where the signage device 10 is installed will be described as an example.

The camera 11 is provided on the upper side of the display unit 12 in the signage device 10 and images an area including an area where the display screen of the display unit 12 of the signage device 10 can be visually recognized. For example, the camera 11 images an area on the front side of the display unit 12. This area is an area where people can pass through and stop. In FIG. 1, the camera 11 can image a person PS on the front surface side of the display unit 12.

The camera 11 has a function of continuously capturing a video at any frame rate and a function of outputting a captured image that is an imaging result.

The display unit 12 displays content. The display unit 12 is, for example, a liquid crystal panel. The display unit 12 displays an image corresponding to the content by driving the elements of each pixel in accordance with a drive signal supplied from a drive control circuit provided in the signage device 10.

When a person is included in a captured image captured by the camera 11, the control unit 13 estimates attributes on the basis of the appearance of the person. The attributes include the person's age, gender, and the like. The signage device 10 displays content corresponding to the estimated attributes on the display unit 12.

Moreover, the control unit 13 transmits the estimated attributes as attribute information to the information processing device 30.

The camera 20a, the camera 20b, and the camera 20c are provided at positions different from each other on the ceiling of the store. At least one of the cameras 20a, the camera 20b, and the camera 20c may be provided on a wall surface or the like instead of the ceiling. When at least one of the camera 20a, the camera 20b, and the camera 20c is provided on the ceiling, a person is imaged in a direction from the ceiling to the floor (from above to below). Therefore, the top of the person's head is imaged, but the face is not imaged, or the face is imaged from an oblique direction, so that the person's face is not imaged as much as possible. For this reason, it is possible to reduce the acquisition of private information.

The camera 20a is provided on the ceiling above the signage device 10 and images a surrounding area including the signage device 10. The camera 20a can image a person when the person is located in front of the signage device 10.

The camera 20b is provided at any position on a flow line (path) between the signage device 10 and the position where the camera 20c is installed in the facility and can image a person moving along the flow line.

The camera 20c is provided at a position different from positions of the camera 20a and the camera 20c. For example, the camera 20c is provided on the ceiling above a checkout counter at a store in a facility. The camera 20c can image a person paying at the checkout counter of the store.

The information processing device 30 has a function of tracking a person imaged by the camera, a function of measuring the effect of the content displayed on the signage device 10, and the like.

The checkout counter terminal 40 is, for example, a point of sales system (POS) terminal. When a payment is made for the product registered at the checkout counter terminal 40, the checkout counter terminal 40 generates information indicating a determined product, price, sales date and time, and the like as sales information and transmits the generated information to the information processing device 30.

FIG. 2 is a schematic block diagram for describing a function of the information processing device 30.

The information processing device 30 includes a communication unit 301, a tracking unit 302, a behavior detection unit 303, a storage unit 304, and a storage processing unit 305.

The communication unit 301 is communicatively connected to the camera 20a, the camera 20b, the camera 20c, and the signage device 10 by wire or wirelessly. The communication unit 301 receives captured images from the camera 20a, the camera 20b, the camera 20c, and the camera 11.

The tracking unit 302 tracks a position of the person imaged by the camera 11 or the camera 20a on the basis of images obtained from other cameras. This tracking is the movement of a person on a path from the vicinity of a position where the signage device 10 is installed to the area imaged by the camera 20c. For example, tracking is performed from the time when a person enters the entrance of the store in accordance with the visual recognition of the content to the time when behavior such as a purchase of a product is performed. Also, even if the person enters the store, the tracking ends when the person leaves the store without making a purchase or the like.

The tracking unit 302 tracks a person by detecting at least a subsequent position of the person in a range where content can be visually recognized during a period when the content is displayed on a display device. The tracking unit 302 can track the person by detecting the position of the person and tracking the position without the association with person identification information that is information for identifying the person. The person identification information is information for identifying the person, and for example, a person's face image and a feature quantity obtained by quantifying a feature for identifying the person's face.

During the period when the content is displayed on the display device, it can be assumed that a person in the range where the content can be visually recognized has visually recognized the content.

Moreover, the tracking unit 302 performs an identification process of whether or not a person imaged by the different cameras is the same person. This identification process includes a first identification process that is an identification process based on a position of a person, a second identification process that is an identification process based on a feature quantity of a person, and a third identification process that is an identification process based on an attribute of a person. The tracking unit 302 performs at least one identification process of the first identification process, the second identification process, and the third identification process.

The behavior detection unit 303 detects the behavior of a person related to the content. It is only necessary for this behavior related to content to be behavior related to the content, for example, behavior triggered by viewing the content. More specifically, when the content is an advertisement for a product, there is behavior of holding the actual product in the person's hands to examine the product, a purchase of the product, an application procedure for purchasing the product, a payment for the provision of a service related to the advertisement content, or the like. When any one of a purchase, application, and payment for a product or service related to the content is performed, the behavior detection unit 303 detects it as behavior. Regarding the purchase or payment that has been performed, if the behavior detection unit 303 can detect that the person has been in the vicinity of the checkout counter terminal 40 at a time when a payment process has been performed at the checkout counter terminal 40 from position information, it can be determined that the person has performed the purchase or payment. Regarding the application that has been performed, if the behavior detection unit 303 can detect that the person has been in the vicinity of the checkout counter terminal 40 at a time when content of the application has been input from a store terminal from the position information, it can be determined that the person has performed the application. The application may be an application for a service, an application for ordering a product, an application for registering as a member of a store, or the like.

The behavior detection unit 303 detects the behavior of a person in a location different from the area (range) where the content can be viewed through the signage device 10. The different location is, for example, a checkout counter, and the behavior detection unit 303 detects behavior such as a purchase, application, or payment as behavior at the checkout counter.

The storage unit 304 stores the behavior and visual recognition opportunity information, which is information corresponding to the presence of the person in the range where the content can be viewed during the period when the content displayed on the signage device 10 can be viewed, in association with each other on the basis of a tracking result of the tracking unit 302 without association with person identification information.

The storage unit 304 stores visual recognition opportunity information and behavior in association with each other on the basis of a location where any one of the purchase, application, and payment has been performed and the tracking result.

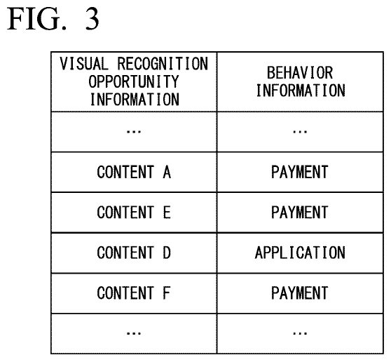

FIG. 3 is a diagram showing an example of measurement information stored in the storage unit 304.

The measurement information is data in which visual recognition opportunity information and behavior information are associated.

It is only necessary for the visual recognition opportunity information to be information indicating the presence in a range where content can be viewed when the content is played. Here, as an example, content identification information for identifying the played content when a visual recognition opportunity is obtained is stored as the visual recognition opportunity information. As shown in FIG. 3, “content A” is stored as visual recognition opportunity information, “payment” is stored as behavior information, and a person located in the vicinity of the signage device 10 when content A is played pays for the purchase of a product related to the content. When the content identification information is used as the visual recognition opportunity information, a relationship between a type of played content and the behavior can be ascertained.

Thus, the storage unit 304 stores the visual recognition opportunity information and the behavior information without association with person identification information for identifying an individual, such as an image of a person.

The storage processing unit 305 stores the behavior information and the visual recognition opportunity information, which is information corresponding to the presence of the person in the range where content can be viewed during the period when the content displayed on the signage device 10 can be viewed, in the storage unit 304 in association with each other on the basis of a tracking result of the tracking unit 302 without association with the person identification information.

The storage processing unit 305 stores information in the storage unit 304, but does not store the face image of a person or a feature quantity obtained from the face image of a person. Therefore, various types of information are stored without association with the person identification information.

Here, a person is imaged by the camera 11, the camera 20a, the camera 20b, and the camera 20c and a captured image is used, but the captured image is not stored in the storage unit 304.

Next, the above-described operation of the content display system S will be described.

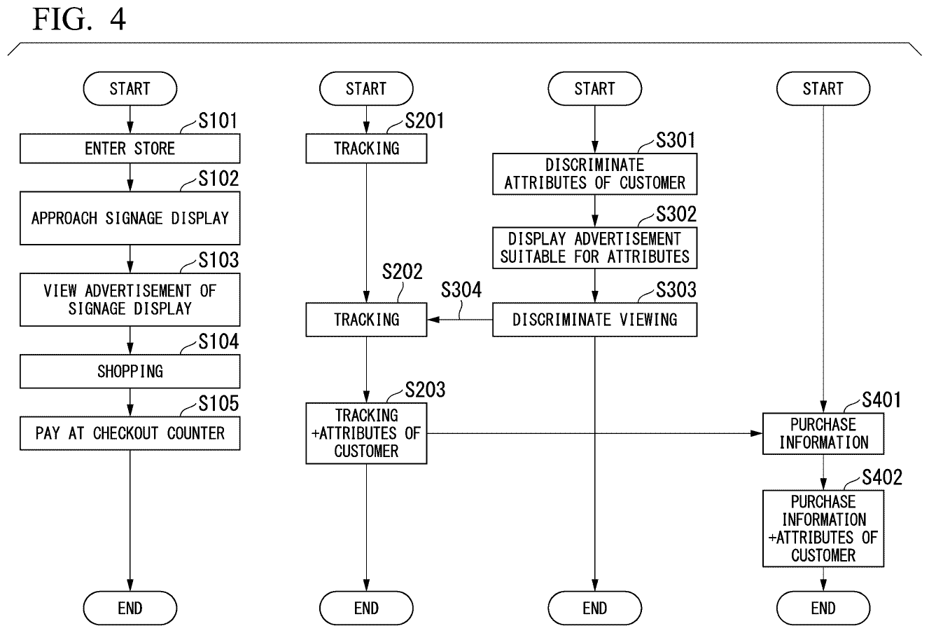

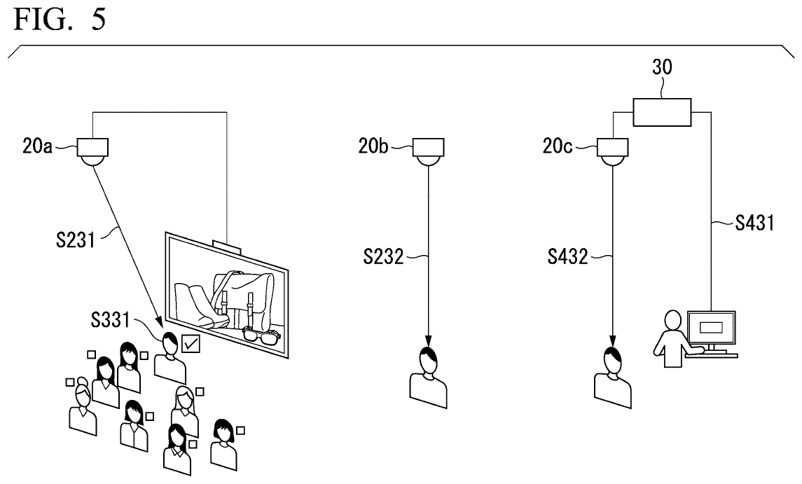

FIG. 4 is a flowchart for describing the operation of the content display system S and FIG. 5 is a conceptual diagram for describing a flow of a process of the content display system S.

When a person enters a store (FIG. 4: step S101), the camera 20a captures an image of an area including the person entering the store and transmits the captured image to the information processing device 30. The information processing device 30 determines whether or not the person is included in the captured image and a position of the person is detected from the captured image if the person is included therein. The tracking unit 302 starts a tracking process (tracking) for the position of the person that has been extracted (FIG. 4: step S201 and FIG. 5: S231).

Here, tracking information in which information indicating an area in which a person is extracted from the captured image obtained from the camera 20a is associated with information indicating that the person is designated as a tracking target is generated. Here, when the tracking process is performed, the tracking unit 302 tracks a person using any data of center coordinates of an area corresponding to the person, coordinates of footsteps of the person, an outline corresponding to the person, and the like in an image in which the person has been imaged, assigns data indicating that content has been viewed to data indicating that tracking is being performed, and tracks the person. Thereby, the position of a person can be tracked without association with information for identifying who the person is (person identification information).

When the person entering the store approaches the display unit 12 of the signage device 10 (FIG. 4: step S102), the signage device 10 captures an image of the person with the camera 11, discriminates attributes by estimating the attributes of the person from the captured image (FIG. 4: step S301), and displays content corresponding to the discriminated attributes on the display unit 12 (FIG. 4: step S302). For example, this content is an advertisement that introduces recommended products for recommendation to consumers of the discriminated attributes.

When the control unit 13 of the signage device 10 detects that only one person is located in the vicinity of the signage device 10, the attributes of the person are discriminated. On the other hand, when a plurality of persons are located in the vicinity of the signage device 10, the control unit 13 extracts a person at a position nearest the signage device 10 and discriminates attributes of the person (FIG. 5: step S331). By discriminating the attributes of the person at the nearest position, it is possible to obtain attributes of an estimated person who is likely to have seen the content displayed on the display unit 12 of the signage device 10. In this case, it is possible to estimate which of the plurality of people is viewing the content in a simple process.

When the content is displayed on the display unit 12, the person views the content (FIG. 4: step S103).

The camera 11 of the signage device 10 continuously captures an image of a person, detects a position of the person included in the captured image, and determines whether or not the person is viewing the content (FIG. 4: step S303). When it is determined that the person is viewing the content, the control unit 13 of the signage device 10 transmits visual recognition opportunity information indicating that the person is viewing the content, attribute information discriminated in step S301, and the captured image to the information processing device 30.

When the information processing device 30 receives the visual recognition opportunity information, the attribute information, and the captured image transmitted from the signage device 10, an identification process is performed for the person included in the captured image and a tracking target person who is the person imaged by the camera 20a. The identification process is performed, and therefore the tracking unit 302 associates the visual recognition opportunity information and the attribute information with the tracking information based on the captured image obtained from the camera 20a (FIG. 4: step S304), and continues tracking (FIG. 4: step S202). Thereby, when it is detected that an advertisement displayed on the signage device 10 has been viewed by a person, it is possible to assign information for marking that the displayed content has been viewed as the attribute information generated in the signage device 10 to tracking information for the captured image obtained from the camera imaging the person viewing the content. Here, the attribute information indicates the age, gender, and the like of the person, but the tracking process can be performed using information that is difficult to identify the person because the person cannot be identified only from the attribute information. Moreover, because the attribute information used for determining the content to be displayed in the signage device 10 can be held and finally stored in the storage unit 304, a relationship between the attributes of the target on which the content is actually displayed and the behavior can be ascertained.

Here, an example of the identification process will be described. The tracking unit 302 performs a first identification process in which an identification process is performed on the basis of the position of the person. That is, the camera 11 of the signage device 10 and the camera 20a can identify the position of the person. For example, when it is determined that a size of the person's face imaged by the camera 11 and a size of the person's face imaged by the camera 20a are the same size (or substantially the same), the person imaged by the camera 11 and the person imaged by the camera 20a can be identified as the same person.

Also, as another method, two cameras 11 of the signage device 10 are provided as a stereo camera and position information indicating the position and depth of the person on the plane is obtained from the signage device 10 on the basis of the captured images obtained from the two cameras. Also, it may be a method of identifying the position of a person by obtaining the coordinates on the plane of the person included in the captured image obtained from the camera 20a and comparing the coordinates with the position information.

Moreover, as yet another method, a depth sensor is provided in the signage device 10 in addition to the camera 11 and a depth direction starting from the signage device 10 is measured, and therefore a position of a person and a distance to the person may be obtained as position information by measuring the distance to the person. Also, it may be a method of identifying the position of the person by obtaining the coordinates on the plane of the person included in the captured image obtained from the camera 20a and comparing the coordinates with the position information.

The tracking unit 302 may perform a second identification process in which an identification process is performed on the basis of a feature quantity of the person. The tracking unit 302 functions as a feature quantity acquisition unit configured to acquire a first feature quantity of the person included in a first image captured by the first camera imaging the range where the content displayed on the display device can be viewed and a second feature quantity of the person included in a second image captured by the second camera imaging a tracking target area.

Using the function of the feature acquisition unit, the tracking unit 302 tracks the person of which second feature quantity corresponding to the first feature quantity is obtained. As for whether or not there is a corresponding relationship between the first feature quantity and the second feature quantity, the tracking unit 302 may determine that there is a corresponding relationship if a degree of similarity between the first feature quantity and the second feature quantity is a certain degree or more.

Here, the number of second cameras may be two or more and may be installed at positions different from each other. In this case, the tracking unit 302 acquires a feature quantity (third quantity) of the person included in the image captured by one second camera and a feature quantity (fourth quantity) of the person included in the image captured by the other second camera and tracks the person whose fourth feature quantity corresponding to the third feature quantity is obtained. Thereby, when there are a plurality of second cameras, the tracking unit 302 can track the person even if the person moves between imaging ranges of the second cameras.

As for whether or not there is a corresponding relationship between the third feature quantity and the fourth feature quantity, the tracking unit 302 may determine that there is a corresponding relationship if the degree of similarity between the first feature quantity and the second feature quantity is a certain degree or more.

The tracking unit 302 may perform a third identification process in which an identification process is performed on the basis of attributes of the person. The tracking unit 302 may have a function as an attribute acquisition unit configured to acquire a first attribute estimated for a person included in an image obtained by imaging the area including the range where the content can be visually recognized and a second attribute estimated for the person included in an image obtained by imaging a tracking target area.

Using the function of the attribute acquisition unit, the tracking unit 302 tracks a person whose second attribute corresponding to the first attribute is obtained. As for whether or not there is a corresponding relationship between the first attribute and the second attribute, the tracking unit 302 may determine that there is a corresponding relationship when the first attribute and the second attribute match. Moreover, the tracking unit 302 may determine that there is a corresponding relationship if a degree of similarity between the first attribute and the second attribute is a certain degree or more.

In this way, it is possible to extract a person identical to a person who is imaged by the camera 11 and whose attributes are estimated from a captured image captured by the camera 20a by identifying the person imaged by the camera 11 and the person imaged by the camera 20a. Thereby, the tracking unit 302 of the information processing device 30 can track a person who is targeted for displaying content by the camera 11 (a person whose attributes are estimated by the camera 11) using a captured image obtained by the camera 20a. Here, while a process for tracking a person is performed, because attribute information is associated with the tracking information, the person is not identified, but the attribute information can be continuously held.

When viewing of the content ends due to the end of the playback time of the content, the person moves around the store to search for a recommended product introduced in the content in the store (FIG. 4: step S104).

Here, the camera 20b continuously performs an imaging process and transmits a captured image to the information processing device 30. When a tracking target person moves from an area imaged by the camera 20a to an area imaged by the camera 20b by moving around, the tracking target person is included in the captured image of the camera 20b. When the tracking unit 302 of the information processing device 30 detects that the person included in the captured image of the camera 20a is included in the captured image of the camera 20b, the detected person is designated as the tracking target and the tracking information is continuously held.

Here, the above-described identification process is also performed in the camera 20a and the camera 20b, and therefore the tracking unit 302 can discriminate whether or not the person included in the captured image of the camera 20a and the person included in the captured image of the camera 20b are the same person.

When a person reaches a shelf with recommended products, the person picks up a recommended product and moves toward a checkout counter.

When a person purchases a product, the person brings the product to the checkout counter and pays at the checkout counter (FIG. 4: step S105).

Here, the camera 20c continuously performs an imaging process and transmits a captured image to the information processing device 30. When the tracking target person arrives at the checkout counter and moves from the area imaged by the camera 20b to the area imaged by the camera 20c, the captured image of the camera 20c includes the tracking target person. When the tracking unit 302 of the information processing device 30 detects that the person included in the captured image of the camera 20b is included in the captured image of the camera 20c, the detected person is tracked as a tracking target (FIG. 4: step S203) and the tracking information is continuously held.

Here, the above-described identification process is also performed in the camera 20b and the camera 20c, and therefore the tracking unit 302 can discriminate whether or not the person included in the captured image of the camera 20b and the person included in the captured image of the camera 20c are the same person.

The behavior detection unit 303 of the information processing device 30 detects the movement of a person on the basis of the captured image obtained from the camera 20c and discriminates whether or not an operation corresponding to a payment has been performed. As a payment operation, for example, when the time when a tracking target person stands at a position in the vicinity of the checkout counter and sales information generated in the checkout counter terminal 40 match or when there is a corresponding relationship in which they are considered to match, it can be determined that the payment has been made. Moreover, as the payment operation, after the product is placed on the checkout counter, it is an operation of taking out a credit card or the like from the wallet and making a payment. When the payment is made in cash, the behavior of taking out cash from the wallet and handing over the cash to the clerk may be detected as an operation of making the payment. When the payment operation is detected, the behavior detection unit 303 detects that the behavior of purchasing the recommended product has been performed. Here, when an application for a service or the like is performed instead of purchasing a product at the checkout counter, the behavior of filling in an application form may be detected as behavior information.

When the payment is completed, the checkout counter terminal 40 transmits the sales information to the information processing device 30 (FIG. 5: step S431). When the storage processing unit 305 of the information processing device 30 receives sales information from the checkout counter terminal 40 (FIG. 4: step S401), attribute information and behavior information are stored in association with each other in the storage unit 304 without association with information for identifying the person (FIG. 4: step S402). Thereby, log information in which the person who has viewed the content of the signage device 10 is associated with the sales information generated by the checkout counter terminal 40 is stored. This log information is analyzed, and therefore it is possible to ascertain whether or not a person (consumer) has purchased a product of an advertisement related to the content that has been viewed.

When the storage in the storage unit 304 has ended, the tracking unit 302 ends the tracking process for the person who has made the payment (FIG. 5: step S432). When the tracking ends, the tracking unit 302 deletes feature quantities (a first feature quantity, a second feature quantity, a third feature quantity, and a fourth feature quantity) held for the person whose tracking has ended. Here, the tracking unit 302 may discard the feature quantity of the person by discarding the tracking information. Thereby, even if the feature quantity is included in the tracking information, it is discarded without being stored in the storage unit 403. Therefore, the storage unit 403 can store the visual recognition opportunity information and the behavior without storing the first feature quantity and the second feature quantity. Moreover, the storage unit 403 can store the visual recognition opportunity information and the behavior without storing the third feature quantity and the fourth feature quantity.

Moreover, the tracking unit 302 deletes attribute information (a first attribute and a second attribute) used for tracking the person whose tracking has ended. Here, the tracking unit 302 may discard the attribute information by discarding the tracking information. Thereby, even if the attribute information is included in the tracking information, the attribute information used for tracking is discarded without being stored in the storage unit 403. Therefore, the storage unit 403 can store visual recognition opportunity information and behavior without storing the first attribute and the second attribute.

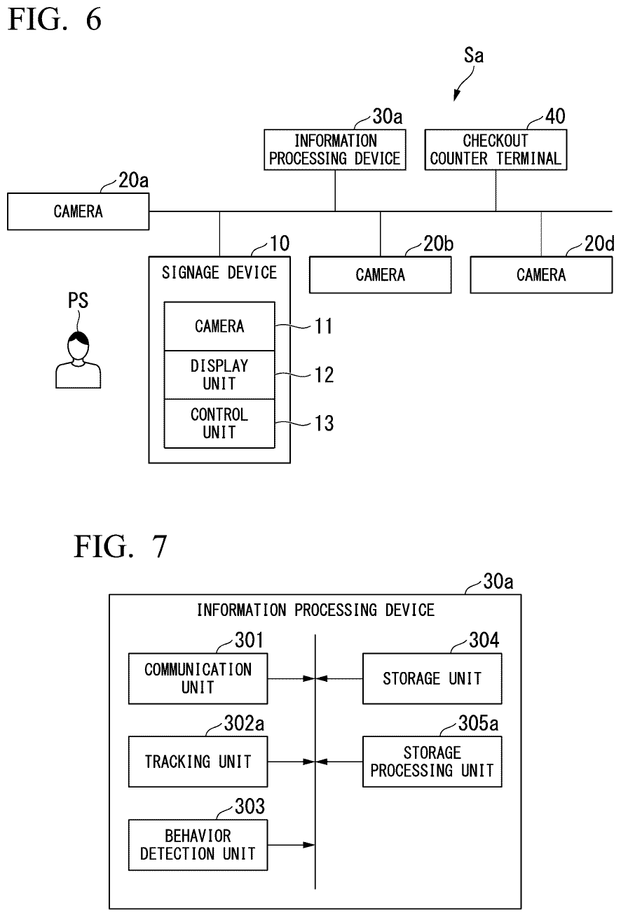

FIG. 6 is a schematic configuration diagram for describing a configuration of the content display system Sa according to another embodiment.

In the content display system Sa, a signage device 10, a plurality of cameras (a camera 20a, a camera 20b, and a camera 20d), an information processing device 30a, a checkout counter terminal 40, and a camera 50 are electrically connected via a communication cable.

Because the signage device 10, the plurality of cameras (the camera 20a and the camera 20b), and the checkout counter terminal 40 are the same as those of the content display system S of FIG. 1, description thereof will be omitted.

The camera 20d has the same function as the camera 20c, but determines whether or not a person is included in a captured image and the attributes of the person are estimated if the person is included therein. The camera 20d transmits the estimated attributes as attribute information to the information processing device 30a. A process in which the camera 20d estimates the attributes is similar to the process in which the signage device 10 estimates the attributes. Therefore, the camera 20d can obtain the same attribute information as the signage device 10 in the case of the same person.

FIG. 7 is a schematic block diagram showing a configuration of an information processing device 30a according to the other embodiment. The information processing device 30a is another form of the information processing device 30 in the above-described content display system S. The information processing device 30a is communicatively connected to the signage device 10, the camera 20a, the camera 20b, the camera 20c, and the checkout counter terminal 40 as in the content display system S described above.

The information processing device 30a includes a communication unit 301, a tracking unit 302a, a behavior detection unit 303, a storage unit 304, and a storage processing unit 305a.

Because functions of the communication unit 301, the behavior detection unit 303, and the storage unit 304 are similar to those of the information processing device 30, they are denoted by reference signs identical to those in FIG. 2 and description thereof will be omitted.

Although a person tracking function of the tracking unit 302a is similar to that of the tracking unit 302, there is a difference that tracking is performed in a state in which no attribute information is held even if the attribute information is estimated in the signage device 10 while the person is tracked.

The storage processing unit 305a determines whether or not the person whose behavior has been detected is a tracking target and the visual recognition opportunity information and the behavior information are stored in the storage unit 304 if the person is a tracking target. Moreover, when the storage processing unit 305a stores the visual recognition opportunity information and the behavior information in the storage unit 304, the visual recognition opportunity information and the behavior information can be stored together with the attribute information obtained from the camera 50.

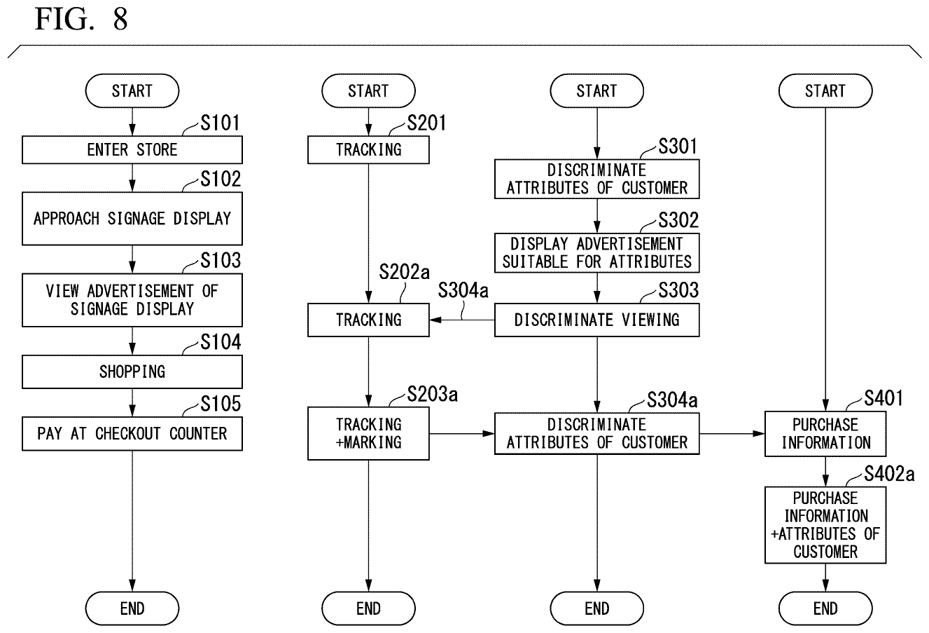

FIG. 8 is an explanatory diagram showing an operation of a content display system S according to yet another embodiment. Here, steps S101 to S105, step S201, steps S301 to S303, and step S401 are denoted by reference signs identical to those in FIG. 4 because they are operations similar to those in FIG. 4 and description thereof will be omitted.

When it is determined that a person is viewing the content in step S303, the control unit 13 of the signage device 10 transmits the visual recognition opportunity information indicating that the person is viewing the content to the information processing device 30 together with the captured image.

When the visual recognition opportunity information and the captured image transmitted from the signage device 10 are received, the information processing device 30 performs an identification process for a person included in the captured image and a tracking target person who is the person imaged by the camera 20a. The identification process is performed, and therefore the tracking unit 302 associates the visual recognition opportunity information with the tracking information based on the captured image obtained from the camera 20a (step S304a) and continues tracking (step S202a). Here, at the stage of tracking a person, it is possible to ascertain that the content has been viewed by holding the visual recognition opportunity information, but the attribute information is not held.

On the other hand, when the tracking target person arrives at the checkout counter and makes a payment, the camera 20d captures an image of an operation of the person making the payment and transmits the captured image to the information processing device 30a. Moreover, the camera 20d estimates attributes of the person making the payment (step S304a) and transmits attribute information indicating the estimation result to the information processing device 30a together with the captured image.

The behavior detection unit 303 of the information processing device 30a detects the movement of a person on the basis of the captured image obtained from the camera 20c and discriminates whether or not an operation corresponding to the payment has been performed.

When the payment is completed, the checkout counter terminal 40 transmits the sales information to the information processing device 30a. When the storage processing unit 305a of the information processing device 30a receives sales information from the checkout counter terminal 40 (step S401), the attribute information received from the camera 20d and behavior information are stored in association with each other in the storage unit 304 without association with information for identifying the person (step S402). Thereby, log information in which the person who has viewed the content displayed on the signage device 10 is associated with the sales information generated by the checkout counter terminal 40 is stored.

According to the present embodiment, because attribute information is not used during tracking, the use of personal information of the person can be avoided as much as possible.

Although the case in which the camera 20d captures an image for tracking a person and estimates the person's attributes from the captured image has been described in the present embodiment, another camera may be provided near the camera 20d and an imaging process for tracking and an imaging process for estimating attributes may be performed with separate cameras.

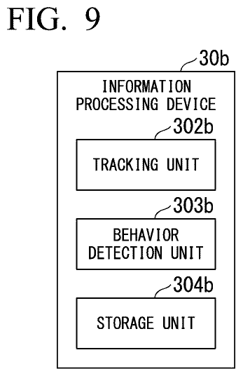

FIG. 9 is a schematic block diagram for describing functions of the information processing device 30b according to another embodiment.

The tracking unit 302b tracks a person by detecting at least a subsequent position of the person in a range where content can be visually recognized during a period when the content is displayed on a display device without association with person identification information for identifying the person.

The behavior detection unit 303b detects the behavior of the person related to the content.

The storage unit 304 stores the behavior and visual recognition opportunity information, which is information corresponding to the presence of the person in the range where the content can be visually recognized during the period when the content is displayed, in association with each other on the basis of a tracking result of the tracking unit 302b without association with the person identification information.

Although the case where the person tracking process is a process of capturing an image of a movement path in a store with a camera and tracking a person on the basis of the captured image has been described in the above-described embodiment, the person tracking process may be performed in a separate method. For example, a position of the terminal device may be measured by a terminal device such as a smartphone or a mobile phone carried by a person and position information that is a measurement result may be used. For example, a global navigation satellite system (GNSS) may be used for measuring position information.

When position information is acquired from a terminal device carried by a person, the information processing device 30 (30a or 30b) may acquire the position information with application software or the like mounted in the terminal device via a wireless communication network of the terminal device. The wireless communication network may be 4G, 5G, LTE, Wi-Fi (registered trademark), or the like.

In this case, when it is determined that viewing has been performed at the signage device 10, the tracking unit 302 (302a or 302b) detects a terminal device whose position information is in an area in front of a display screen of the signage device 10 and tracks a person on the basis of the position information of the terminal device. In this case, the information processing device 30 (30a or 30b) continuously acquires position information from the terminal device and generates tracking information by associating the position information with visual recognition opportunity information. Also, after the terminal device of the position information reaches a place corresponding to the checkout counter, when a payment is made by a person, the behavior detection unit 303 (303b) stores the held visual recognition opportunity information and sales information in association with each other in the storage unit 304 (304b).

In this way, because the position information of the terminal device such as a smartphone or a mobile phone carried by the person is acquired and the person is tracked, it is possible to identify the position of the tracking target person without identifying an individual based on the appearance of the person.

Moreover, a program for implementing functions of the processing unit in FIG. 1 is recorded on a computer-readable recording medium, and the program recorded on the recording medium may be read into a computer system and executed to perform construction management. The “computer system” used here is assumed to include an operating system (OS) or hardware such as peripheral devices.

Moreover, the “computer system” is assumed to include a homepage provision environment (or display environment) if a WWW system is used.

Moreover, the “computer-readable recording medium” refers to a flexible disk, a magneto-optical disc, a read-only memory (ROM), a portable medium such as a compact disc-ROM (CD-ROM), or a storage device such as a hard disk embedded in the computer system. Furthermore, the “computer-readable recording medium” is assumed to include a medium that holds a program for a certain period of time, such as a volatile memory inside a computer system serving as a server or a client. Moreover, the above-described program may be a program for implementing some of the above-described functions. Further, the above-described function may be implemented in combination with a program already recorded on the computer system. Moreover, the above-described program may be stored in a predetermined server and the program may be distributed (downloaded or the like) via a communication circuit in response to a request from another device.

Although embodiments of the present invention have been described in detail above with reference to the drawings, specific configurations are not limited to the embodiments and other designs and the like may also be included without departing from the scope of the present invention.

### REFERENCE SIGNS LIST

10 Signage device
11, 20a, 20b, 20c, 20d, 50 Camera
12 Display unit
13 Control unit
30, 30a, 30b Information processing device
40 Checkout counter terminal
301 Communication unit
302, 302a, 302b Tracking unit
303, 303b Behavior detection unit
304, 304b Storage unit
305, 305a Processing unit

What is claimed is:

1. An information processing device comprising:
a tracking unit configured to track a person by detecting at least a subsequent position of the person in a range where content can be visually recognized during a period when the content is displayed on a display device;
a behavior detection unit configured to detect behavior of the person related to the content; and
a storage unit that stores the behavior and visual recognition opportunity information, which is information corresponding to the presence of the person in the range during the period, in association with each other on the basis of a tracking result of the tracking unit without association with person identification information for identifying the person.

2. The information processing device according to claim 1, wherein the behavior detection unit is configured to detect the behavior of the person in a location different from the range.

3. The information processing device according to claim 2,
wherein the behavior detection unit is configured to detect a purchase, application, or payment for a product or service related to the content as the behavior, and
wherein the storage unit stores the visual recognition opportunity information and the behavior in association with each other on the basis of a location where any one of the purchase, the application, and the payment has been performed and the tracking result.

4. The information processing device according to claim 1, wherein the tracking unit is configured to track the person without the association with the person identification information.

5. The information processing device according to claim 1, wherein the tracking unit is configured to acquire position information measured by a terminal device carried by the person and tracks the person on the basis of the acquired position information.

6. The information processing device according to claim 1, further comprising:
a feature quantity acquisition unit configured to acquire a first feature quantity of the person included in a first image captured by a first camera imaging a range in which the content displayed on the display device can be viewed and a second feature quantity of the person included in a second image captured by a second camera imaging a tracking target area,
wherein the tracking unit is configured to track the person whose second feature quantity corresponding to the first feature quantity is obtained, and
wherein the storage unit stores the visual recognition opportunity information and the behavior without storing the first feature quantity and the second feature quantity.

7. The information processing device according to claim 6,
wherein the tracking unit is configured to delete the first feature quantity and the second feature quantity for a person whose tracking has ended.

8. The information processing device according to claim 1, further comprising:
an attribute acquisition unit configured to acquire a first attribute estimated for a person included in an image obtained by imaging an area including the range and a second attribute estimated for a person included in an image obtained by imaging a tracking target area,
wherein the tracking unit is configured to track a person whose second attribute corresponding to the first attribute is obtained, and
wherein the storage unit stores the visual recognition opportunity information and the behavior without storing the first attribute and the second attribute.

9. The information processing device according to claim 8,
wherein the tracking unit is configured to delete the first attribute and the second attribute for a person whose tracking has ended.

10. The information processing device according to claim 1, wherein the storage unit stores behavior of a person located at a position closest to the display device when a plurality of persons are located in the range.

11. The information processing device according to claim 1, wherein the storage unit stores the visual recognition opportunity information including content identification information for identifying content.

12. An information processing method comprising:
tracking a person by detecting at least a subsequent position of the person in a range where content can be visually recognized during a period when the content is displayed on a display device;
detecting behavior of the person related to the content; and
storing the behavior and visual recognition opportunity information, which is information corresponding to the presence of the person in the range during the period, in association with each other in a storage unit on the basis of a tracking result without association with person identification information for identifying the person.
